(19) United States
(12) Patent Application Publication
(10) Pub. No.: US 2011/0113315 A1
(43) Pub. Date: May 12, 2011

(54) COMPUTER-ASSISTED RICH INTERACTIVE NARRATIVE (RIN) GENERATION

(75) Inventors: Narendranath Datha, Bangalore (IN); Joseph M. Joy, Redmond, WA (US); Ajay Manchepalli, Bengalore (IN)

(73) Assignee: MICROSOFT CORPORATION, Redmond, WA (US)

(21) Appl. No.: 13/008,484

(22) Filed: Jan. 18, 2011

Related U.S. Application Data
(63) Continuation-in-part of application No. 12/347,868, filed on Dec. 31, 2008.

(51) Int. Cl. G06F 17/00

(52) U.S. Cl. 715/202

(57) ABSTRACT

The computer-assisted rich interactive narrative generation technique described herein employs a Rich Interactive Narratives (RIN) data model to provide for the computer-assisted creation of rich interactive experiences called RINs. A RIN is a narrative that runs like a movie with a sequence of scenes that follow one after another. A user can stop the narrative, explore the environment associated with the current scene (or other scenes if desired), and then resume the narrative where it left off. The technique allows for the automatic and dynamic generation of RINs using very little input from a user—say, for example, a search query—whereupon the technique automatically generates a RIN. An author/user can guide the process of narrative creation by having portions of the creation process automatically performed by the computer-implemented technique and portions guided and assisted by one or more authors/users.

### CROSS-REFERENCE TO RELATED APPLICATIONS

This application is a continuation-in-part of a prior application entitled “Generalized Interactive Narrative” which was assigned Ser. No. 12/347,868 and filed Dec. 31, 2008.

### BACKGROUND

Generating compelling, media-rich, interactive content for on screen viewing and interaction can be very time consuming and also requires specialized knowledge in interactive content creation. This can be a significant barrier to how rapidly and widely media-rich interactive content can be produced and disseminated. Finding and organizing information and formatting it to produce interactive content is time-consuming and typically requires an advanced skill set.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The computer-assisted rich interactive narrative generation technique described herein employs a Rich Interactive Narratives (RIN) data model, as well as pluggable experience streams to provide for the computer-assisted creation of rich interactive experiences called RINs. A RIN is a narrative that runs like a movie with a sequence of scenes that follow one after another (although like a DVD movie, a RIN could be envisioned as also having isolated scenes that are accessed through a main menu). A user can stop the narrative, explore the environment associated with the current scene (or other scenes if desired), and then resume the narrative where it left off. The computer-assisted rich interactive narrative generation technique allows for the automatic and dynamic generation of narratives using very little input from a user—say, for example, a search query—whereupon the technique automatically generates a RIN. An author/user can guide the process of narrative creation by having portions of the creation process automatically performed by the computer-implemented technique and portions of the creation process guided and assisted by the author/user.

The computer-assisted rich interactive generation technique described herein has three complementary aspects. One aspect of the technique automatically decides on the overall content, layout and sequencing of a RIN. In a second aspect of the technique, given content and sequence (manually or automatically created), the technique generates alternative views, such as, for example, a “table of contents” view and a summary view. In a third aspect, the technique interacts with computer services hosted elsewhere to alter the source of a narrative on the fly and to create completely new content on the fly.

### DESCRIPTION OF THE DRAWINGS

The specific features, aspects, and advantages of the disclosure will become better understood with regard to the following description, appended claims, and accompanying drawings where:

FIG. 1 depicts a schematic of a RIN, including a narrative, scenes and segments, which is automatically created by employing one embodiment of the computer-assisted rich interactive narrative generation technique.

FIG. 2 depicts another schematic of a RIN which can be automatically created by employing another embodiment of the computer-assisted rich interactive narrative generation technique.

FIG. 3 depicts viewports for viewing experience streams of a RIN which can be automatically created by employing the computer-assisted rich interactive narrative generation technique.

FIG. 4 depicts an exemplary structure of an experience stream employed in one embodiment of the computer-assisted rich interactive narrative generation technique.

FIG. 5 depicts an exemplary trajectory aspect of an experience stream employed in one embodiment of the computer-assisted rich interactive narrative generation technique.

FIG. 6 is a simplified diagram of an embodiment of a system for processing RIN data to provide a narrated traversal of arbitrary media types and user-explorable content of the media.

FIG. 7 depicts a generalized and exemplary environment representing one way of implementing the creation, deposit, retention, accessing and playing of RIN.

FIG. 8 depicts a flow diagram of an exemplary process for automatically creating a RIN using one embodiment of the computer-assisted rich interactive narrative generation technique.

FIG. 9 depicts a flow diagram of another exemplary process for creating alternate views of a RIN by employing one embodiment of the computer-assisted rich interactive narrative generation technique.

FIG. 10 is an exemplary architecture for practicing one exemplary embodiment of the computer-assisted rich interactive narrative generation technique described herein.

FIG. 11 is an exemplary architecture for incorporating dynamically generated content in a media player for playing RINs according to one exemplary embodiment of the computer-assisted rich interactive narrative generation technique described herein.

FIG. 12 is a schematic of an exemplary computing environment which can be used to practice the computer-assisted rich interactive narrative generation technique.

### DETAILED DESCRIPTION

In the following description of the computer-assisted rich interactive narrative generation technique, reference is made to the accompanying drawings, which form a part thereof, and which show by way of illustration examples by which the computer-assisted rich interactive narrative generation technique described herein may be practiced. It is to be understood that other embodiments may be utilized and structural changes may be made without departing from the scope of the claimed subject matter.

1.0 Computer-Assisted Rich Interactive Narrative Generation Technique

The following sections provide an overview of the computer-assisted rich interactive narrative generation technique, a high level description of a RIN data model employed in one embodiment of the technique, as well as exemplary processes and exemplary architectures for practicing the technique.

1.1 Overview of RINs

The computer-assisted rich interactive narrative generation technique described herein employs a RIN data model to allow for the automatic and dynamic computer-assisted generation of rich interactive experiences called RINs. The automatically generated RINs can be played and interacted with on a media player which will be described in greater detail later with respect to an exemplary architecture for implementing various embodiments of the technique.

1.1.1 RIN Data Model

By way of background, the RIN Data Model is discussed before providing details of the technique. In general, embodiments of the RIN data model described herein are made up of abstract objects that can include, but are not limited to, narratives, segments, screenplays, resource tables, experience streams, sequence markers, highlighted regions, artifacts, keyframe sequences and keyframes. The sections to follow will describe these objects and the interplay between them in more detail. Additionally, the RIN Data Model is described in a co-pending application entitled “Data Model and Player Platform for Rich Interactive Narratives” filed Jan. 18, 2011 and assigned Ser. No. 13/008,324.

1.1.1.1 The Narrative and Scenes

The RIN data model provides seamless transitions between narrated guided walkthroughs of arbitrary media types and user-explorable content of the media, all in a way that is completely extensible. In the abstract, the RIN data model can be envisioned as a narrative that runs like a movie with a sequence of scenes that follow one after another (although like a DVD movie, a RIN could be envisioned as also having isolated scenes that are accessed through a main menu). A user can stop the narrative, explore the environment associated with the current scene (or other scenes if desired), and then resume the narrative where it left off.

A scene is a sequentially-running chunk of the RIN. As a RIN plays end-to-end, the boundaries between scenes may disappear, but in general navigation among scenes can be non-linear. In one implementation, there is also a menu-like start scene that serves as a launching point for a RIN, analogous to the menu of a DVD movie.

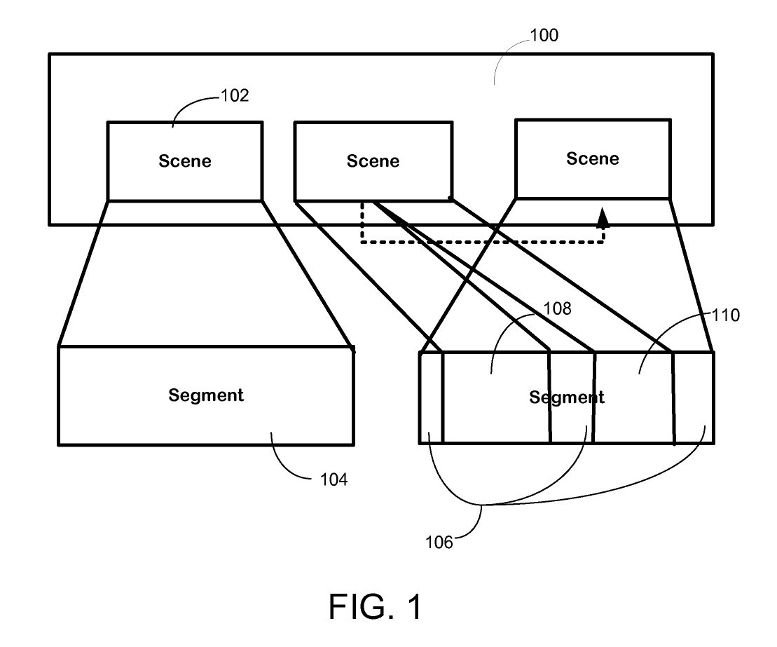

However, a scene is really just a logical construct. The actual content or data that constitutes a linear segment of a narrative is contained in objects called RIN segments. As shown in FIG. 1, a scene 102 of a RIN 100 can be composed of a single RIN segment 104, or it can be put together using all or portions of multiple segments 106, 108, 110 (some of which can also be part of a different scene). Thus, a scene can be thought of as references into content that is actually contained in RIN segments. Further, it is possible for a scene from one RIN to reference RIN segments from other RINs. This feature can be used to, for example, create a lightweight summary RIN that references portions of other RINs. Still further, one RIN segment may play a first portion of an experience stream and the next RIN segment plays a remaining portion of the segment. This can be used to enable seamless transitions between scenes, as happens in the scenes of a movie.

In one embodiment of the RIN data model, a provision is also made for including auxiliary data. All entities in the model allow arbitrary auxiliary data to be added to that entity. This data can include, for example (but without limitation), the following. It can include metadata used to describe the other data. It can also include data that fleshes out the entity, which can include experience-stream specific content. For example, a keyframe entity (i.e., a sub-component of an experience stream, both of which will be described later) can contain an experience-stream-specific snapshot of the experience-stream-specific state. The auxiliary data can also be data that is simply tacked on to a particular entity, for purposes outside the scope of the RIN data model. This data may be used by various tools that process and transform RINs, in some cases for purposes quite unrelated to playing of a RIN. For example, the RIN data model can be used to represent annotated regions in video, and there could be auxiliary data that assigns certain semantics to these annotations (say, identifies a “high risk” situation in a security video), that are intended to be consumed by some service that uses this semantic information to make some business workflow decision (say precipitate a security escalation). The RIN data model can use a dictionary entity called Auxiliary Data to store all the above types of data. In the context of the narrative, metadata that is common across the RIN segments, such as, for example, descriptions, authors, and version identifiers, are stored in the narrative's Auxiliary Data entity.

1.1.1.2 RIN Segment

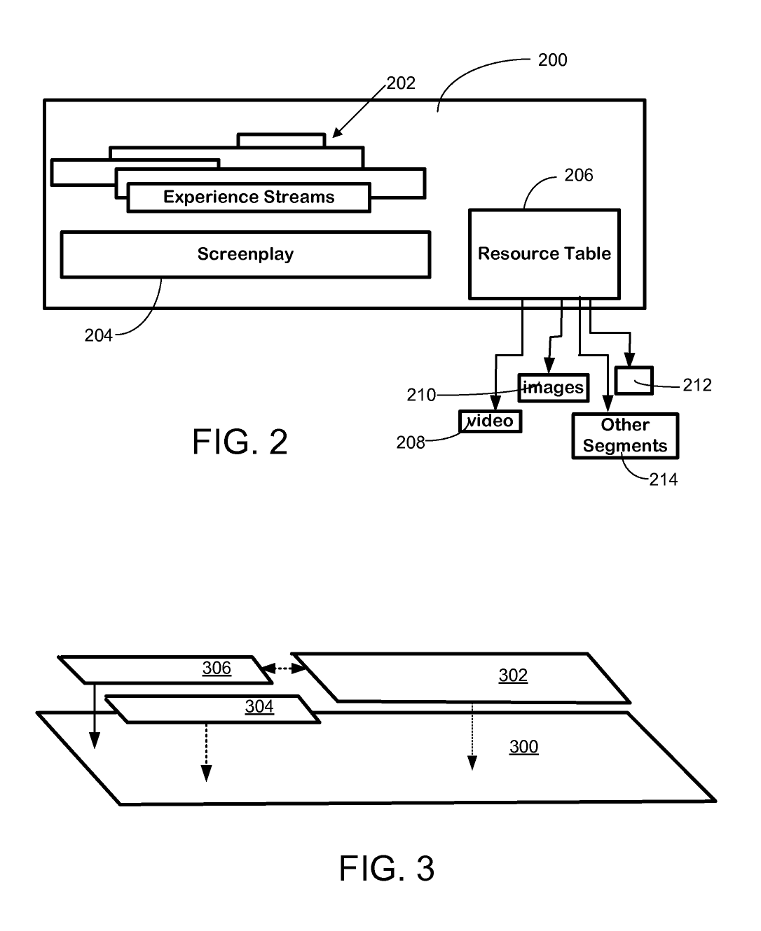

A RIN segment contains references to all the data necessary to orchestrate the appearance and positioning of individual experience streams for a linear portion of a RIN. Referring to FIG. 2, the highest level components of the RIN segment 200 include one or more experience streams 202 (in the form of the streams themselves or references to where the streams can be obtained), at least one screenplay 204 and a resource table 206. The RIN segment can also include arbitrary auxiliary data as describe previously. In one implementation, a RIN segment takes the form of a 4-tuple (S, C, O, A). S is a list of references to experience streams; C (which is associated with the screenplay) is a list layout constraints that specify how the experience streams share display screen and audio real estate; O (which is also associated with the screenplay) is a set of orchestration directives (e.g., time coded events); and A (which is associated with the resource table) is a list of named, time coded anchors, used to enable external references.

In general, the experience streams compose to play a linear segment of the narrative. Each experience stream includes data that enables a scripted traversal of a particular environment. Experience streams can play sequentially, or concurrently, or both, with regard to other experience streams. However, the focus at any point of time can be on a single experience stream (such as a Photosynth Synth), with other concurrently playing streams having secondary roles (such as adding overlay video or a narrative track). Experience streams will be described in more detail in a later section.

In general, a screenplay is used to orchestrate the experience streams, dictating their lifetime, how they share screen and audio real estate, and how they transfer events among one another. Only one screenplay can be active at a time. However, in one implementation, multiple screenplays can be included to represent variations of content. For example, a particular screenplay could provide a different language-specific or culture-specific interpretation of the RIN segment from the other included screenplays.

More particularly, a screenplay includes orchestration information that weaves multiple experience streams together into a coherent narrative. The screenplay data is used to control the overall sequence of events and coordinate progress across the experience streams. Thus, it is somewhat analogous to a movie script or an orchestrator conductor's score. The screenplay also includes layout constraints that dictate how the visual and audio elements from the experience streams share display screen space and audio real estate as a function of time. In one implementation, the screenplay also includes embedded text that matches a voiceover narrative, or otherwise textually describes the sequence of events that make up the segment. It is also noted that a screenplay from one RIN segment can reference an experience stream from another RIN segment.

However, the orchestration information associated with the screenplay can go beyond simple timing instructions such as specifying when a particular experience stream starts and ends. For example, this information can include instructions whereby only a portion of an experience stream is played rather than the whole stream, or that interactivity capabilities of the experience stream be disabled. Further, the screenplay orchestration information can include data that enables simple interactivity by binding user actions to an experience stream. For example, if a user “clicks” on prescribed portion of a display screen, the screenplay may include an instruction which would cause a jump to another RIN segment in another scene, or to shut down a currently running experience stream. Thus, the screenplay enables a variety of features, including non-linear jumps and user interactivity.

An experience stream generally presents a scene from a virtual “viewport” that the user sees or hears (or both) as he or she traverses the environment. For example, in one implementation a 2D viewport is employed with a pre-defined aspect ratio, through which the stream is experienced, as well as, optionally, audio specific to that stream is heard. The term viewport is used loosely, as there may not be any viewing involved. For example, the environment may involve only audio, such as a voiced-over narrative, or a background score.

With regard to the layout constraints, the screenplay includes a list of these constraints which are applicable to the aforementioned viewports created by the experience streams involved in the narrative. In general, these layout constraints indicate the z-order and 2D layout preferences for the viewports, well as their relative sizes. For example, suppose four different experience streams are running concurrently at a point in time in a narrative. Layout constraints for each experience stream dictate the size and positioning of each streams viewport. Referring to FIG. 3, an exemplary configuration of the viewports 300, 302, 304, 306 for each of the four experience streams is shown relative to each other. In addition, in implementations where audio is involved, the layout constraints specify the relative audio mix levels of the experience streams involving audio. These constraints enable the proper use of both screen real estate and audio real estate when the RIN is playing. Further, in one implementation, the relative size and position of an experience stream viewport can change as a function of time. In other words, the layout can be animated.

Thus, each experience stream is a portal into a particular environment. The experience stream projects a view onto the presentation platform's screen and sound system. A narrative is crafted by orchestrating multiple experience streams into a storyline. The RIN segment screenplay includes layout constraints that specify how multiple experience stream viewports share screen and audio real estate as a function of time.

In one implementation, the layout constraints also specify the relative opacity of each experience stream's viewport. Enabling experience streams to present a viewport with transparent backgrounds give great artistic license to authors of RINs. In one implementation, the opacity of a viewport is achieved using a static transparency mask, designated transparent background colors, and relative opacity levels. It is noted that this opacity constrain feature can be used to support transition functions, such as fade-in/fade-out.

With regard to audio layout constraints, in one implementation, these constraints are employed to share and merge audio associated with multiple experience streams. This is conceptually analogous to how display screen real estate is to be shared, and in fact, if one considers 3D sound output, many of the same issues of layout apply to audio as well. For example, in one version of this implementation a relative energy specification is employed, analogous to the previously-described opacity specification, to merge audio from multiple experience streams. Variations in this energy specification over time are permissible, and can be used to facilitate transitions, such as audio fade-in/fade-out.

As for the aforementioned resource table, it is generally a repository for all, or at least most, of the resources referenced in the RIN segment. All external Uniform Resource Identifiers (URIs) referenced in experience streams are resource table entries. Resources that are shared across experience streams are also resource table entries. Referring again to FIG. 2, one exemplary implementation of the resource table includes reference metadata that enables references to external media (e.g., video 208, standard images 210, gigapixel images 212, and so on), or even other RIN segments 214, to be robustly resolved. In some implementations, the metadata also includes hints for intelligently scheduling content downloads; choosing among multiple options if bandwidth becomes a constraint; and pausing a narrative in a graceful manner if there are likely going to be delays due to ongoing content uploads.

1.1.1.3 RIN Experience Streams

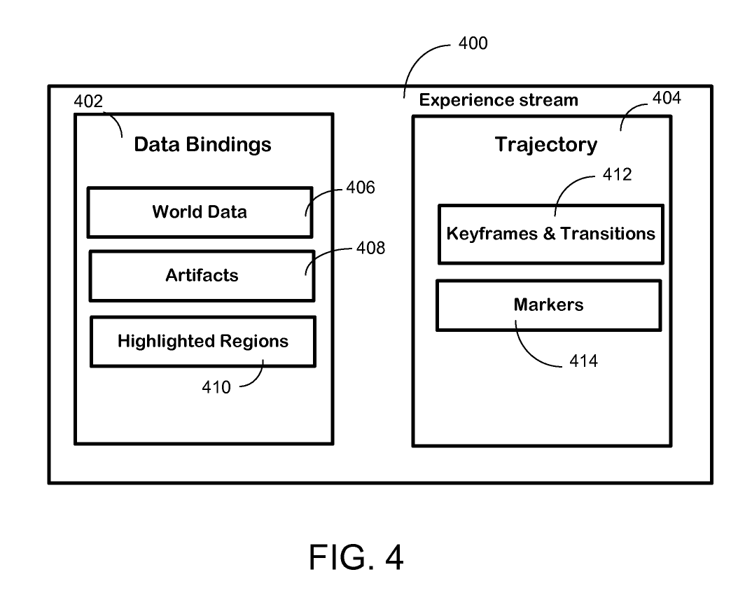

The term experience stream is generally used to refer to a scripted path through a specific environment. In addition, experience streams support pause-and-explore and extensibility aspects of a RIN. In one embodiment illustrated in FIG. 4, an experience stream 400 is made up of data bindings 402 and a trajectory 404. The data bindings include environment data 406, as well as artifacts 408 and highlighted regions 410. The trajectory includes keyframes and transitions 412 and markers 414. An experience stream can also include auxiliary data as describe previously. For example, this auxiliary data can include provider information and world data binding information. Provider information is used in processes that render RINs, as well processes that enable authoring or processing of RINs, to bind to code that understands the specific experience stream (i.e., that understands the specific environment through which the experience is streaming). The world data binding information defines the concrete instance of the environment over which the experience streams runs.

Formally, in one implementation, an experience stream is represented by a tuple (E, T, A), where E is environmental data, T is the trajectory (which includes a timed path, any instructions to animate the underlying data, and viewport-to-world mapping parameters as will be described shortly), and A refers to any artifacts and region highlights embedded in the environment (as will also be described shortly).

Data bindings refer to static or dynamically queried data that defines and populates the environment through which the experience stream runs. Data bindings include environment data (E), as well as added artifacts and region highlights (A). Together these items provide a very general way to populate and customize arbitrary environments, such as virtual earth, photosynth, multi-resolution images, and even “traditional media” such as images, audio, and video. However, these environments also include domains not traditionally considered as worlds, but which are still nevertheless very useful in conveying different kinds of information. For example, the environment can be a web browser; the World Wide Web, or a subset, such as the Wikipedia; interactive maps; 2D animated scalable vector graphics with text; or a text document; to name a few.

Consider a particular example of data bindings for an image experience stream in which the environment is an image—potentially a very large image such as a gigapixel image. An image experience stream enables a user to traverse an image, embedded with objects that help tell a story. In this case the environmental data defines the image. For example, the environment data could be obtained by accessing a URL of the image. Artifacts are objects logically embedded in the image, perhaps with additional metadata. Finally, highlights identify regions within the image and can change as the narrative progresses. These regions may or may not contain artifacts.

Artifacts and highlights are distinguished from the environmental data as they are specifically included to tell a particular story that makes up the narrative. Both artifacts and highlights may be animated, and their visibility may be controlled as the narrative RIN segment progresses. Artifacts and highlights are embedded in the environment (such as in the underlying image in the case of the foregoing example), and therefore will be correctly positioned and rendered as the user explores the environment. It is the responsibility of an experience stream renderer to correctly render these objects. It is also noted that the environment may be a 3D environment, in which case the artifacts can be 3D objects and the highlights can be 3D regions.

It is further noted that artifacts and region highlights can serve as a way to do content annotation in a very general, extensible way. For example, evolving regions in a video or photosynth can be annotated with arbitrary metadata. Similarly, portions of images, maps, and even audio could be marked up using artifacts and highlights (which can be a sound in the case of audio).

There are several possibilities for locating the data that is needed for rendering an experience stream. This data is used to define the world being explored, including any embedded artifacts. The data could be located in several places. For example, the data can be located within the aforementioned Auxiliary Data of the experience stream itself. The data could also be one or more items in the resource table associated with the RIN segment. In this case, the experience stream would contain resource references to items in the table. The data could also exist as external files referenced by URLs, or the results of a dynamic query to an external service (which may be a front for a database). It is noted that it is not intended that the data be found in just one of these locations. Rather the data can be located in any combination of the foregoing locations, as well as other locations as desired.

The aforementioned trajectory is defined by a set of keyframes. Each keyframe captures the state of the experience at a particular point of time. These times may be in specific units (say seconds), relative units (run from 0.0 to 1.0, which represent start and finish, respectively), or can be gated by external events (say some other experience stream completing). Keyframes in RINs capture the “information state” of an experience (as opposed to keyframes in, for instance, animations, which capture a lower-level visual layout state). An example of an “information state” for a map experience stream would be the world coordinates (e.g., latitude, longitude, elevation) of a region under consideration, as well as additional style (e.g., aerial/road/streetside/etc.) and camera parameters (e.g., angles, tilt, etc). Another example of an information state, this time for a relationship graph experience stream, is the graph node under consideration, the properties used to generate the neighboring nodes, and any graph-specific style parameters.

Each keyframe also represents a particular environment-to-viewport mapping at a particular point in time. In the foregoing image example, the mappings are straightforward transformations of rectangular regions in the image to the viewport (for panoramas, the mapping may involve angular regions, depending on the projection). For other kinds of environments, keyframes can take on widely different characteristics.

The keyframes are bundled into keyframe sequences that make up the aforementioned trajectory through the environment. Trajectories are further defined by transitions, which define how inter-keyframe interpolations are done. Transitions can be broadly classified into smooth (continuous) and cut-scene (discontinuous) categories, and the interpolation/transition mechanism for each keyframe sequence can vary from one sequence to the next.

A keyframe sequence can be thought of as a timeline, which is where another aspect of a trajectory comes into play--namely markers. Markers are embedded in a trajectory and mark a particular point in the logical sequence of a narrative. They can also have arbitrary metadata associated with them. Markers are used for various purposes, such as indexing content, semantic annotation, as well as generalized synchronization and triggering. For example, context indexing is achieved by searching over embedded and indexed sequence markers. Further, semantic annotation is achieved by associating additional semantics with particular regions of content (such as a particular region of video is a ball in play; or a region of a map is the location of some facility). A trajectory can also include markers that act as logical anchors that refer to external references. These anchors enable named external references to be brought into the narrative at pre-determined points in the trajectory. Still further a marker can be used to trigger a decision point where user input is solicited and the narrative (or even a different narrative) proceeds based on this input. For example, consider a RIN that provides a medical overview of the human body. At a point in the trajectory of an experience stream running in the narrative that is associated with a marker, the RIN is made to automatically pause and solicit whether the user would like to explore a body part (e.g., the kidneys) in more detail. The user indicates he or she would like more in-depth information about the kidneys, and a RIN concerning human kidneys is loaded and played.

A trajectory through a photosynth is easy to envision as a tour through the depicted environment. It is less intuitive to envision a trajectory through other environments such as a video or an audio only environment. As for a video, a trajectory through the world of a video may seem redundant, but consider that this can include a “Ken Burns” style pan-zoom dive into subsections of video, perhaps slowing down or even reversing time to establish some point. Similarly, one can conceive of a trajectory through an image, especially a very large image, as panning and zooming into portions of an image, possibly accompanied by audio and text sources registered to portions of the image. A trajectory through a pure audio stream may seem contrived at first glance, but it is not always so. For example, a less contrived scenario involving pure audio is an experience stream that traverses through a 3D audio field, generating multi-channel audio as output. Pragmatically, representing pure audio as an experience stream enables manipulation of things like audio narratives and background scores using the same primitive (i.e., the experience stream) as used for other media environments.

It is important to note that a trajectory can be much more than a simple traversal of an existing (pre-defined) environment. Rather, the trajectory can include information that controls the evolution of the environment itself that is specific to the purpose of the RIN. For example, the animation (and visibility) of artifacts is included in the trajectory. The most general view of a trajectory is that it represents the evolution of a user experience—both of the underlying model and of the users view into that model.

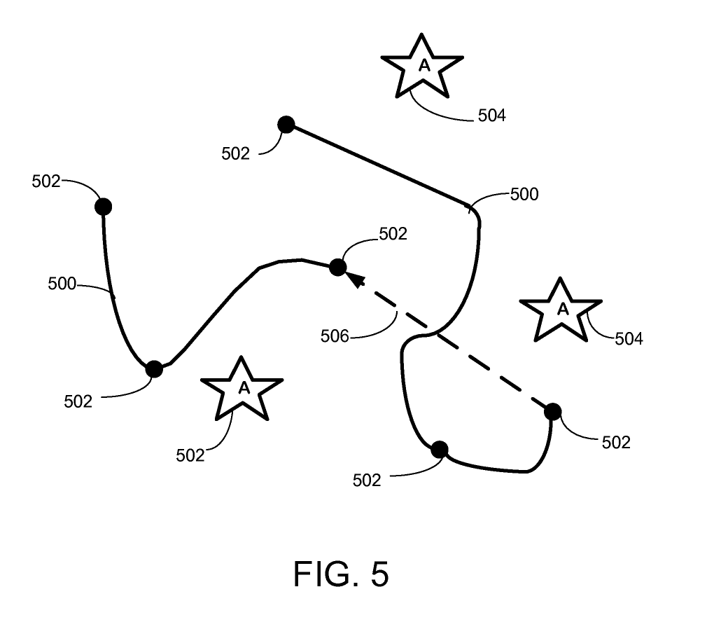

In view of the foregoing, an experience stream trajectory can be illustrated as shown in FIG. 5. The bolded graphics illustrate a trajectory 500 along with its markers 502 and the stars indicated artifacts or highlighted regions 504. The dashed arrow 506 represents a “hyper jump” or “cut scene” —an abrupt transition, illustrating that an experience stream is not necessarily restricted to a continuous path through an environment.

1.1.1.4 Exemplary RIN System

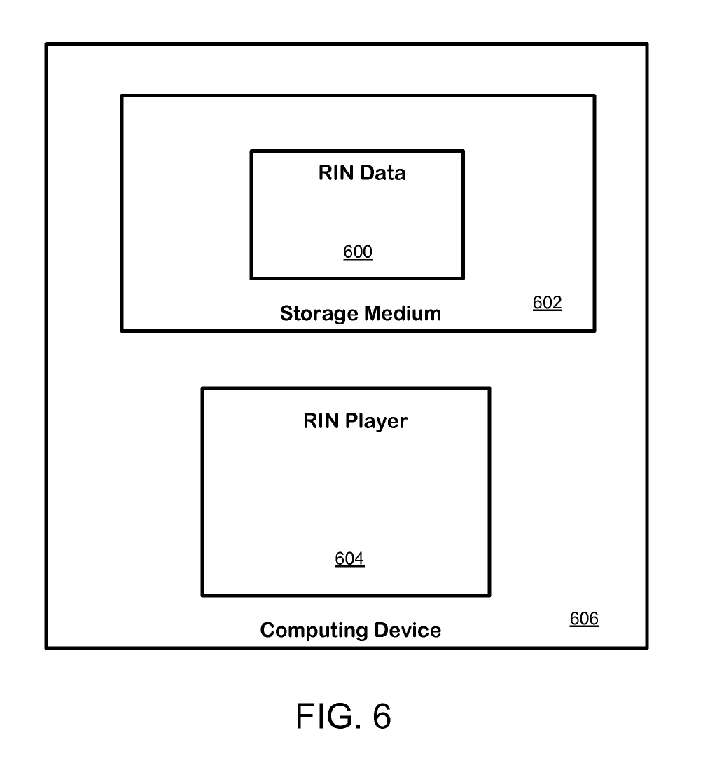

Given the foregoing RIN data model, the following exemplary system of one embodiment for processing RIN data to provide a narrated traversal of arbitrary media types and user-explorable content of the media can be realized, as illustrated in FIG. 6. In this exemplary RIN system, the RIN data 600 is stored on a computer-readable storage medium 602 (as will be described in more detail later in the exemplary operating environments section) which is accessible during play-time by a RIN player 604 running on a user's computing device 606 (such as one of the computing devices described in the exemplary operating environments section). The RIN data 600 is input to the user's computing device 606 and stored on the computer-readable storage medium 602.

As described previously, this RIN data 600 includes a narrative having a prescribed sequence of scenes, where each scene is made up of one or more RIN segments. Each of the RIN segments includes one or more experience streams (or references thereto), and at least one screenplay. Each experience stream includes data that enables traversing a particular environment created by a one of the aforementioned arbitrary media types whenever the RIN segment is played. In addition, each screenplay includes data to orchestrate when each experience stream starts and stops during the playing of the RIN and to specify how experience streams share display screen space or audio playback configuration.

As for the RIN player 604, this player accesses and processes the RIN data 600 to play a RIN to the user via an audio playback device, or video display device, or both, associated with the user's computing device 606. The player also handles user input, to enable the user to pause and interact with the experience streams that make up the RIN.

1.2 RIN Implementation Environment

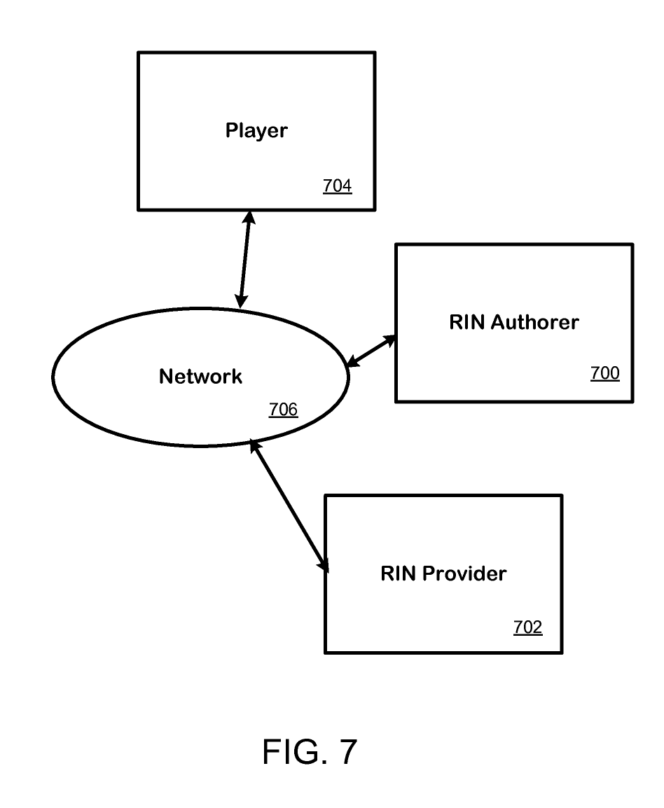

A generalized and exemplary environment representing one way of implementing the creation, deposit, retention, accessing and playing of RIN is illustrated in FIG. 7. An instance of a RIN constructed in accordance with the previously-described data model is captured in a RIN document or file. This RIN document is considered logically as an integral unit, even though it can be represented in units that are downloaded piecemeal, or even assembled on the fly.

A RIN document can be generated in any number of ways. It could be created manually using an authoring tool. It could be created automatically by a program or service using the computer assisted rich interactive narrative described herein. Or it could be some combination of the above. RIN authorers are collectively represented in FIG. 7 by the authorer block 700.

RIN documents, once authored are deposited with one or more RIN providers as collectively represented by the RIN provider block 702 in FIG. 7. The purpose of a RIN provider is to retain and provide RINs, on demand, to one or more instances of a RIN player. While the specifics on the operation of a RIN provider is beyond the scope of this application, it is noted that in one implementation, a RIN provider has a repository of multiple RINs and provides a search capability a user can employ to find a desired RIN. The RIN player or players are represented by the RIN player block 704 in FIG. 7. A RIN player platform for playing RINs will be described in more detail in the sections to follow.

In the example of FIG. 7, the RIN authorers, RIN providers and RIN player are in communication over a computer network 706, such as the Internet or a proprietary intranet. However, this need not be the case. For example, in other implementations any one or more of the RIN authorers, RIN providers and RIN players can reside locally such that communications between them is direct, rather than through a computer network.

1.3 Overview of the Technique

The technique described herein employs the above-described RIN data model and aforementioned RIN implementation environment to automatically and dynamically generate RINs using the computer-assisted technique described herein. User input can be provided to alter or enhance the dynamic RIN generation process.

The computer-assisted rich interactive narrative generation technique described herein has three complementary aspects. One aspect of the technique automatically decides on the overall content and layout and sequencing. In a second aspect of the technique, given content and sequence (manually or automatically created), the technique generates alternative views, such as for example, a table of contents view and summary views. In a third aspect, the technique interacts with computer services hosted elsewhere to alter the source of a narrative on the fly and to create completely new content on the fly.

An overview of computer-assisted rich interactive narrative generation technique having been provided, the following sections provide exemplary processes and exemplary architectures for practicing the technique.

1.4 Creation of Computer-Assisted RINs

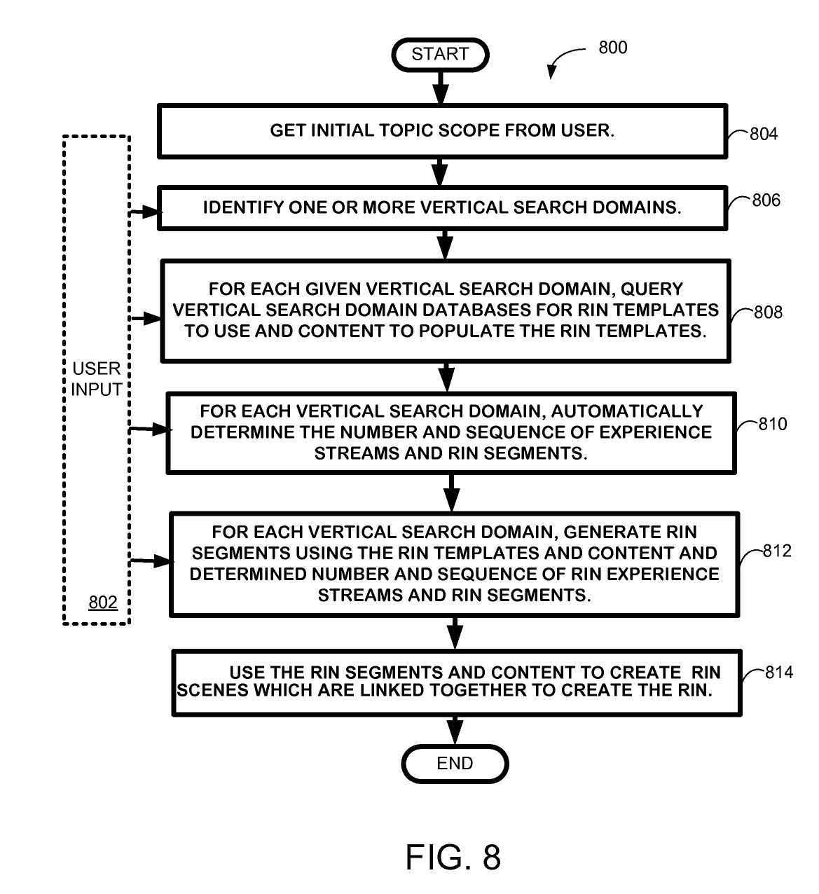

FIG. 8 shows an exemplary flow diagram for a first aspect of computer assisted rich interactive narrative creation—a process 800 for automatically generating RINs. As shown in FIG. 8, the technique optionally takes inputs 702 from one or more human users at various points in the RIN creation as will be discussed in more detail later.

As shown in FIG. 8, block 804, initial information is obtained from a user indicating the topic scope of the narrative. This could be a simple as an initial topic term, or could be a more involved wizard that guides the user to choose from various categories and choices. Then, as shown in block 804, the technique determines which vertical search domain(s) to focus on—for example, a movie database domain, the travel domain, and so forth. This vertical search domain can be determined by the user explicitly picking a domain, or by using various known user intent extraction algorithms that determine category and user intent from text the user initially specified.

As shown in blocks 808, 810 and 812, for each vertical search domain, the following steps are performed. Vertical databases are queried for “RIN templates” that are previously constructed patterns specialized for the vertical search domain (as shown in block 808). For example, a RIN template can include a set of database query templates, which coupled with user-provided input produces a concrete set of database queries that can query one or more databases or services and obtain content that is used to populate the RIN experience stream data. For example it could be a list of images, or videos, or objects with map coordinates. The generated query could be something like {all items with tags that include “x”, “y” and “z”, and which are about events that occurred between 1908 and 1912}. The vertical databases can also be queried (block 808) for content that has more structure than a list of items. For example the results can include lists of topics and sub-topics in a named hierarchy. Once the vertical databases have been queried, the specific number of segments, their sequence, and the makeup of each segment—which experience stream instances to create, and orchestration (which includes timing and layout) are analyzed and determined, as shown in block 812. For example, a template includes specific rules to construct the RIN. These rules can be crafted by humans for a vertical domain, and can be in the form of code (script) that is specialized to the vertical domain. In other words the templates can include active, domain-specific logic to construct the RIN. For example: if the vertical domain is information about a movie, the template can have a script that does the following:
1. Compose a content browser experience stream that lists various sub-categories of information related to the movie-trailer, actors, site locations, expert reviews, latest comments in the blogosphere and twitter.
2. For each category, generate a RIN segment that uses the appropriate kinds of experience streams to best represent the data—a simple video ES for the trailer, a map ES to show the locations, a content browser to display all the expert reviews, and so forth.
3. It constructs a vocal narrative script using summaries of the expert comments, a few blogosphere comments, a summary of the shot locations.
4. It constructs trajectories by using some algorithm—it could be a random algorithm that touches on a few locations in the map, a few comments on the blogosphere.

The RINs and related media are then generated using the templates (block 814). This is a mechanical process of going from the structural, logical definition of content to actual instances of the experience streams. For example, narrative text is piped into a speech synthesizer, the list of geographic coordinates and sequence of places to visit is converted into a Map ES. This part is not domain specific, but rather content specific-maps, audio, music, collections of media, and so forth. This RIN creation can include synthesized speech, synthesized images and videos, and trajectories (paths) through the different experiences. For example, a particular path can be through a map illustrating a way to go from point A to point B (where point A and B were determined in earlier stages of the process). The RIN segments and content are used to create RIN scenes, which are linked together to create a RIN.

At each stage represented by blocks 804, 806, 808, 810 and 812 the user (or multiple users) can guide and add information to the process. The user can suggest new topics to explore as sub-narratives. For example, when creating a RIN on the human body, the system could create a high-level narrative, but the user could then suggest sub topics on parts of the human body. The user can modify automatically generated content. The user can modify parameters used to generate content. The user can delete inappropriate/irrelevant content and finally the user can add manually created content.

Additionally, user feedback/interaction can be recorded to improve the automatically generated process, for example, using conventional machine learning techniques that take into account user feedback to change internal weights of elements used in the automatic narrative element generation.

1.4 Creation of Computer-Assisted Alternate Views for RINs

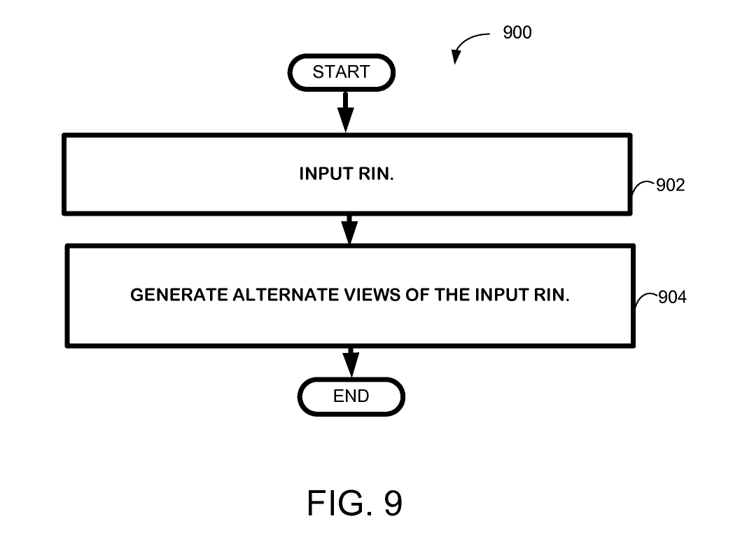

A second aspect of the computer assisted rich interactive narrative creation technique is the automatic and dynamic creation of alternative views. As shown in FIG. 9, block 902, content and a sequence for a RIN are input. As shown in block 904, one or more alternate views based on the content and sequence of the RIN are then generated.

Alternate views analyze an existing narrative or collection of narratives, and generate derived content that can serve various purposes, including indexes/tables of contents (called the “console view”) and summary views through the narrative—perhaps visiting highlighted areas. For example, a “Table of Contents” can be generated by creating an instance of a “Console” experience stream that consists of a 2D layout of items, and populating it with thumbnails, and summary text from each topic in the RIN, and linking the action of clicking on an item to jumping to that portion of the RIN. As another example, a “summary of the RIN” segment that summarizes the content of a RIN can be generated by extracting a few keyframes from the content and sequence of the RIN, picking a few topics, and organizing the extracted keyframes and topics to summarize the rich interactive narrative.

1.5 Computer-Assisted Narrative Generation with External Services

A third aspect of computer-assisted rich interactive narrative creation is the use of one or more external services (on the same computing device or on some other computing device perhaps somewhere on the Internet or intranet) to assist in generating the RIN. These external services can influence the flow of the narrative and generate completely fresh content.

In influencing the flow of the narrative, in one embodiment of the technique, as user navigates through the narrative, information state can be accumulated, and this information state can be transferred to an external service. For example, the service can analyze this information state, taking into account any other state it maintains (perhaps responses from other users), and suggest a change in the flow of the narrative.

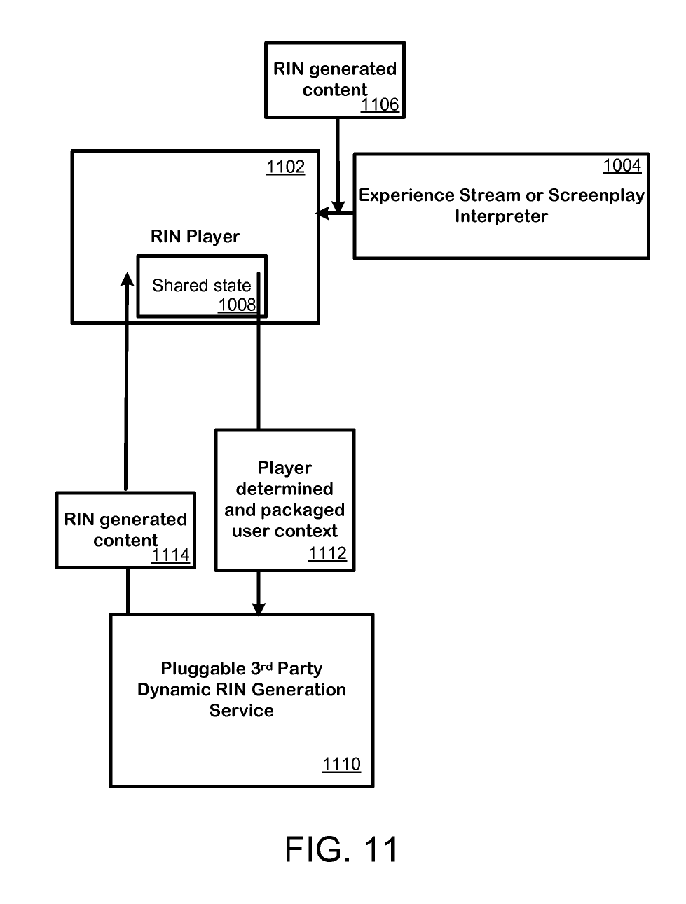

In the generation of completely fresh content, fresh content can be generated based on the user's history and preferences navigating a narrative. In this case, the narrative is created in bits and pieces as the user plays it. This aspect of the computer assisted rich interactive narrative creation technique is described in greater detail with respect to FIG. 11.

1.6 Exemplary Architectures

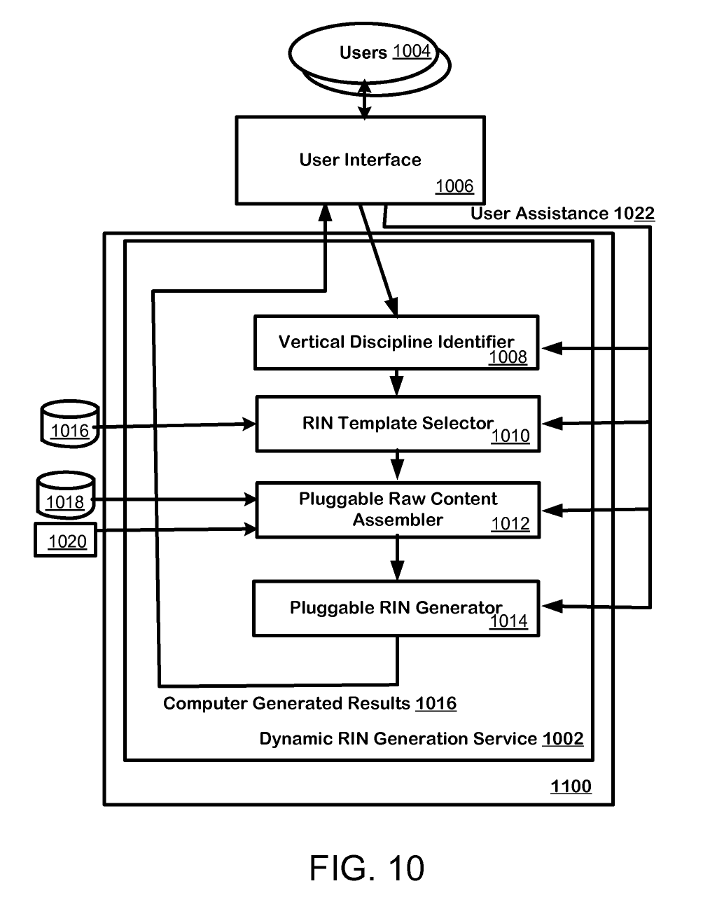

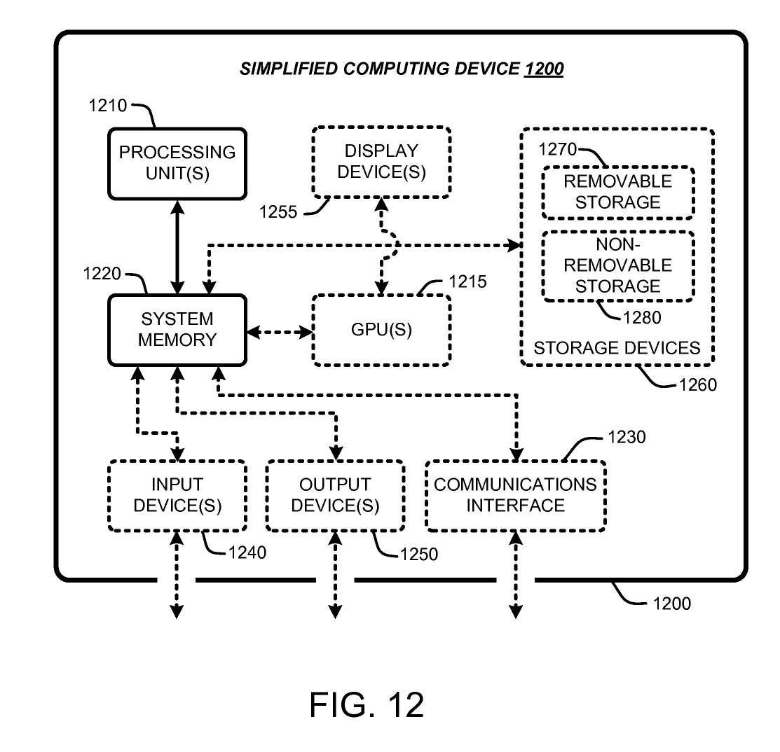

FIG. 10 shows an exemplary architecture 1000 for employing the computer assisted rich interactive narrative creation technique. This architecture includes a dynamic RIN generation service module 1002 that resides on one or more computing devices 1200 that will be described in greater detail with respect to FIG. 12. Block 1004 depicts one or more end users which can collaboratively work to generate content. Block 1006 depicts a user interface. The user interface 1006 provides for interaction with users and can be in the form of a web-based user interface, or a user interface embodied in one or more applications. In other words the user interface 1006 may not be a single component, but represents the component or components responsible for translating user input into computer commands. Machine-generated content can be dynamically incorporated into the experience of a user viewing or interacting with the content. The user interface 1006 interacts with the computing device 1200 (for example, via an API, which can be either a local or remote API). Block 1002 depicts a dynamic RIN generation service. The dynamic RIN generation service 1002 is the component that implements computer-assisted RIN generation functionality. It can be all on a single computing device (located on the same or different computing device as the user interface components), or its components can be implemented as a set of services on multiple machines. The dynamic RIN generation service 1002 is made up of the following components: a vertical domain identifier 1008, a RIN template selector 1010, RIN raw content assemblers 1012 and RIN generators 1014. These components will be described in greater detail in the following paragraphs.

The vertical domain identifier 1008 decides on the vertical search domains used to target the content creation, based in input from the user. This input can range form a simple search term entered by the user, to more structured “user context” or user intent captured by the user interface. There are various conventional ways of determining user intent. Depending on which vertical search domain is chosen, additional pluggable components may be employed specific to the particular vertical search domain. Examples of vertical search domains include: movies and entertainment, health advice, mathematical problem solving, and so forth. The decision about which vertical search domain to select to pick can either be based on direct choice by the user, or by implicitly picking a domain based on analysis of input (including user context/user intent) provided by the user, much as “user query intent” is determined automatically by current generation web search engines, using existing techniques for automatic query intent determination.

The RIN template selector 1010 consults a database of “RIN Templates” 1016, choosing one appropriate for the vertical search domain selected. These RIN templates contain information that identifies what the overall layout/structure of the RIN will be, as well as which set of content assemblers (block 1012) and RIN generators (block 1014) need to be invoked.

The RIN raw content assemblers 1012 are vertical search domain-specific components responsible for querying various sources of data to assemble content for the generated RIN. Sources can include schematized databases (block 1018) on vertical subject matter (for example movie databases, health records, curated information about history, and so forth). Sources can also include unstructured or semi-structured information 1020 from the Internet or Intranets, that may be collaboratively created. Examples include the Wikipedia or weather information or movie databases. Query terms obtained by the user—either during initial interaction or subsequent interaction can be used to determine topics and query for content for those topics. Note that the content assemblers 1012 can be pluggable (i.e. can be added later)—so more sophisticated assemblers, or ones that handle new vertical search domains, can be added into this architecture. In particular specialized content assemblers can interpret specific structures in the information on supplied by the client user interface 1006 (including user context—which is explained later). For example, this user context can include the user's performance on solving a particular math multiple choice question. A particular content assembler 1012 that is specialized to assembling dynamically generated math problems can interpret this information in making content choices.

The RIN generators (block 1014) can also be pluggable, i.e. future generators can be added targeting a particular vertical domain, or incorporating newer algorithms for generation. These RIN generators 1014 are responsible for actually constructing entire narratives or portions of narratives (segments, screenplays, resource tables, and so forth). Generation can include synthesis of audio narration from text obtained from the raw content assemblers 1012 and synthesis of musical scores from MIDI content or other musical content obtained from the raw content assemblers 1012. Generation can also include the incorporation of pre-created content (such as musical pieces, images, and text) and generation of “trajectories” through content—such as, for example, paths through a Deep Zoom image. These trajectories can be generated automatically using guidelines specified in the RIN templates, or can use data from content obtained from the raw content assemblers 1012, such as community-contributed GPS tracks. Generation can also include existing algorithms to generate paths given a set of waypoints may be applied to generated trajectories (say timed walkthroughs through a map). As discussed above, the entire narrative and portions of a narrative, which together with pre-generated content comprise a full narrative, can be generated. Dynamically generated RIN content can include an entire (self-contained) narrative, segments, screenplays within a segment and experience streams. This freshly generated content can be played by a player that will be discussed below.

End-user information from the user interface, including user-context, can be used to make choices during content generation. Generated content 1016 is then merged with other previously-generated content and served back to the user. “Served back” may be in the form of pre-generated narratives that are saved to a narrative repository for later use, or they can be dynamically served to end users who want to experience a dynamically-generated narrative.

As discussed previously, the process of generating RIN content can be optionally user-guided (block 1020) at any stage of the process. The user can provide feedback that includes picking from a set of options—such as which vertical search domain to choose, what weights to use when searching for content, what format styles to use when generating content, and so forth. The user feedback can include adding or manually editing content or launching fresh requests for machine-assisted content of sub-topics. Feedback can also include providing relevance feedback to be used for better automatic content generation. This user intervention is optional—the architecture 1000 can always pick defaults based on specified defaults or past user preferences.

The following paragraphs describe how computer-generated content can be incorporated dynamically into the narrative viewing/interacting experience. This is one way (a particularly compelling way) computer assisted RIN generation may be used (another way would be to pre-generate content.). The relevant aspects of an architecture 1100 that that enables this scenario and includes a RIN player 1102 is shown in FIG. 11.

The actions for dynamically incorporating content according to one embodiment of the technique are as follows. An experience stream or screen play interpreter (block 1104) triggers an incorporation of dynamic content (block 1106). An event triggering the incorporation of dynamic content can include a user explicitly selecting an option in a user interface to launch dynamic content creation. Or dynamic content can be triggered by a user interacting with an existing narrative. Alternately active content in a narrative (say encapsulated in an experience stream) can spontaneously invoke dynamic content generation. This can be based on a certain amount of time having elapsed, or by analysis of past actions of the user triggering the dynamic generation event.

Once the dynamic content invocation is triggered, the RIN player 1102 determines and packages user context (block 1112) and sends it to the dynamic RIN generation service 1110. This user context (block 1112) can include a shared state 1108 (shared state is global information maintained in the RIN player that is available to all experience streams and the orchestrator) accumulated by experience streams. For example, as the user is interacting with one or more experience streams, the experience streams can write entries to a shared “message board”. This message board is quite general. For example, the message board can save the users responses to questions posed by an experience stream (perhaps the experience stream poses a multiple-choice math problem. The user's response (selection) to this problem can be saved in the shared state 1108. The user context can also include history of a user's interactions with player controls—for example, a set of narratives visited and navigation choices. Additionally, the user content can include explicit input from the user, for example, terms to be used in creating dynamic content.

The configurable dynamic RIN generation service 1110 then processes the information and dynamically generates fresh RIN content 1114, can include an entire (self contained) narrative, segments, screenplays within a segment, and experience streams. The process used by this pluggable external service to analyze and generate all or portions of fresh content can either use the processes described previously or some entirely different process specific to the domain. In fact the ability to connect to a 3^{rd} party external service that can provide its own logic for RIN content generation is an important source of extensibility of the system, as it allows scenario-driven logic by 3^{rd} parties to be incorporated into the interactive RIN generation process. This enables some of the scenarios explained later in the document, such as the personalized lesson plan scenario. (It should be noted that the dynamic RIN generation service 1110 can be any type of third party content generation service. For example, it can be a specialized service generating RIN content for a specialized scenario.) This freshly-generated content 1114 can then be played by the RIN player 1102. From the end users perspective, they may not be aware that this content was freshly generated. For example a user using this system to be coached in mathematics may just perceive this as a series of questions, not realizing that each question is dynamically generated taking the users' past performance into account.

1.7 Exemplary Applications for Creating RINs.

There are various possible applications for creating and using RINs generated by the technique described herein. For example, the technique can be used to create customized interpretations of complex data similar to having an expert walk a user through complex data, explaining it (whether medical reports, financial data, software code, results of scientific experiments). Alternately, the technique can be used to, with a little help from a user, create a customized itinerary/multimedia narrative guide to a city on a specific day, taking into account time-specific attractions and user preferences. Another application for the technique is to construct personalized lesson plans, taking into account a user's set of topics of interest, as well as what they already know. The technique can also be used to generate customized advertisements that are both interesting and useful, relevant and actionable to the users. Actionable includes the ability to conduct business transactions. Yet another application for the technique is to provide recipes that are “narrated”, and that also can be customized and then shared by others. Still yet another application for the technique is to generate a narrative that explains how two or more things are related. Lastly, another application for the technique includes mobile applications of machine assisted RINs, including being able to construct a RIN on the fly based on location and time in addition to other user input.

It is also possible to incorporate business transactions into RINs. For example, a RIN can display a customized view of a subset of a business's items—say draperies/furniture of a particular color/type, followed by an opportunity to purchase them. Or it is possible to create a customized travel itinerary followed by the opportunity to do travel bookings, or to create an environment where users can create content that can be then sold/rented to others using a RIN market place. Customized lesson plans can also be created and sold to people using RINs.

2.0 Exemplary Operating Environments:

The computer-assisted rich interactive narrative generation technique described herein is operational within numerous types of general purpose or special purpose computing system environments or configurations. FIG. 12 illustrates a simplified example of a general-purpose computer system on which various embodiments and elements of the computer-assisted rich interactive narrative generation technique, as described herein, may be implemented. It should be noted that any boxes that are represented by broken or dashed lines in FIG. 12 represent alternate embodiments of the simplified computing device, and that any or all of these alternate embodiments, as described below, may be used in combination with other alternate embodiments that are described throughout this document.

For example, FIG. 12 shows a general system diagram showing a simplified computing device 1200. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the computer-assisted rich interactive narrative generation technique, the device should have a sufficient computational capability and system memory to enable basic computational operations. In particular, as illustrated by FIG. 12, the computational capability is generally illustrated by one or more processing unit(s) 1210, and may also include one or more GPUs 1215, either or both in communication with system memory 1120. Note that that the processing unit(s) 1210 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 12 may also include other components, such as, for example, a communications interface 1230. The simplified computing device of FIG. 12 may also include one or more conventional computer input devices 1240 (e.g., pointing devices, keyboards, audio input devices, video input devices, haptic input devices, devices for receiving wired or wireless data transmissions, etc.). The simplified computing device of FIG. 12 may also include other optional components, such as, for example, one or more conventional computer output devices 1250 (e.g., display device(s) 1255, audio output devices, video output devices, devices for transmitting wired or wireless data transmissions, etc.). Note that typical communications interfaces 1230, input devices 1240, output devices 1250, and storage devices 1260 for general-purpose computers are well known to those skilled in the art, and will not be described in detail herein.

The simplified computing device of FIG. 12 may also include a variety of computer readable media. Computer readable media can be any available media that can be accessed by computer 1200 via storage devices 1260 and includes both volatile and nonvolatile media that is either removable 1270 and/or non-removable 1280, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the computer-assisted rich interactive narrative generation technique described herein, or portions thereof, may be stored, received, transmitted, or read from any desired combination of computer or machine readable media or storage devices and communication media in the form of computer executable instructions or other data structures.

Finally, the computer-assisted rich interactive narrative generation technique described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for creating a rich interactive narrative, comprising:
receiving an initial topic scope for a rich interactive narrative (RIN);
identifying one or more vertical search domains related to the initial topic scope;
automatically querying one or more vertical search domains to find RIN templates and content based on the initial scope;
automatically determining number and sequence of RIN experience streams and RIN segments to be used to create the RIN;
automatically generating RIN segments using the RIN templates and content and determined number and sequence of RIN experience streams; and
automatically using the RIN segments to create RIN scenes which are linked together to create the RIN.

2. The computer-implemented process of claim 1, further comprising a user viewing and interacting with the created RIN.

3. The computer-implemented process of claim 2 wherein new content is dynamically generated as the user views and interacts with the created RIN.

4. The computer-implemented process of claim 3 wherein an event generated by an experience stream triggers the dynamic generation of the new content.

5. The computer-implemented process of claim 1, wherein the initial topic scope is explicitly provided by an author.

6. The computer-implemented process of claim 1, wherein the initial topic scope is based on a user-intent determination.

7. The computer-implemented process of claim 1, wherein each RIN segment further comprises:
a list of references to experience streams, each experience stream comprising a scripted path through an environment and a viewport with which to view the environment;
a list of layout constraints that specify how the experience streams share display space and audio space.
a list of orchestration directives that orchestrate when particular experience streams become visible and audible; and
a list of named, time coded anchors that are used to enable external references into a RIN segment.

8. The computer-implemented process of claim 1, wherein identifying vertical search domains related to the initial topic scope further comprises feedback from an author that suggests sub-topics to identify one or more additional vertical search domains.

9. The computer-implemented process of claim 1, wherein querying vertical databases for RIN templates and data based on the initial topic scope further comprises feedback from an author to modify automatically generated content, modify parameters used to generate automatically generated content, and add manually generated content.

10. The computer-implemented process of claim 1, wherein determining number and sequence of RIN experience streams and RIN segments further comprises feedback from an author to modify the number and sequence of RIN experience streams and RIN segments determined.

11. The computer-implemented process of claim 1, further comprising using an external service to generate new content.

12. The computer-implemented process of claim 1, wherein a RIN template further comprises:
a series of steps that generate an interactive narrative of a general type that is later dynamically populated with content.

13. The computer-implemented process of claim 1, further comprising using an external service to generate a RIN template.

14. The computer-implemented process of claim 1, wherein the RIN template further comprises:
a set of query templates, which coupled with user input, automatically produces a set of database queries that can query one or more databases or services to obtain content that is used to populate RIN experience streams.

15. The computer-implemented process of claim 1, further comprising automatically generating a table of contents for the RIN.

16. A computer-implemented process for using third party plug in services for creating a rich interactive narrative (RIN), comprising:
receiving an event that triggers an incorporation of dynamic content into a RIN;
determining user context of a user for which the RIN is being prepared;
dynamically generating the dynamic content for the RIN at a pluggable external service using the determined user context; and
using the dynamically generated content to provide the RIN to the user.

17. The computer-implemented process of claim 16 wherein the external service used to generate the dynamically generated content further comprises an external service that generates pluggable RIN templates.

18. The computer-implemented process of claim 17 wherein the external service used to generate the dynamically generated content further comprises an external service that provides pluggable content used to populate the RIN templates.

19. A system for generating alternate views for a rich interactive narrative, comprising:
a general purpose computing device;
a computer program comprising program modules executable by the general purpose computing device, wherein the computing device is directed by the program modules of the computer program to,
input content and a sequence for a rich interactive narrative; and
generate one or more alternate views of the content and sequence of the rich interactive narrative.

20. The system of claim 19 wherein the alternate view is a table of content view that summarizes the content of the rich interactive narrative, further comprising:
extracting key frames from the content and sequence of the rich interactive narrative; and
organizing the extracted key frames to summarize the rich interactive narrative.
